(19) United States
(12) Patent Application Publication
(10) Pub. No.: US 2023/0319748 A1
(43) Pub. Date: Oct. 5, 2023

(54) USER DEVICE AND METHOD FOR OPERATING SIDELINK COMMUNICATION

(71) Applicant: HUAWEI TECHNOLOGIES CO., LTD., Shenzhen (CN)

(72) Inventors: Mario Hernán CASTAÑEDA GARCIA, Munich (DE); Richard STIRLING-GALLACHER, Munich (DE); Xitao GONG, Munich (DE)

(73) Assignee: HUAWEI TECHNOLOGIES CO., LTD., Shenzhen (CN)

(21) Appl. No.: 18/332,139

(22) Filed: Jun. 9, 2023

Related U.S. Application Data
(63) Continuation of application No. PCT/EP2020/085552, filed on Dec. 10, 2020.

(51) Int. Cl. H04W 56/00; H04B 17/318

(52) U.S. Cl. CPC H04W 56/0015; H04B 17/328

(57) ABSTRACT

A user equipment arranged to operate sidelink communication. The user equipment includes a transceiver that is configured to receive a first signal from a first synchronization source. The user equipment further includes a processor which is configured to obtain a set of sidelink synchronization signal (SLSS), identifiers (IDs). The processor is further configured to operate power control of transmission of a synchronization signal based on the first signal and the set of SLSS IDs. The user equipment manifests a reduced power consumption, an improved energy efficiency as well as an efficient synchronization coverage expansion, in and out of network coverage of a base station.

### CROSS-REFERENCE TO RELATED APPLICATIONS

This application is a continuation of International Application No. PCT/EP2020/085552, filed on Dec. 10, 2020, the disclosure of which is hereby incorporated by reference in its entirety.

### TECHNICAL FIELD

The present disclosure relates generally to the field of wireless communication; and more specifically, to a user device and a method for operating sidelink communication.

### BACKGROUND

In wireless communication technologies, such as a fifth-generation (5G), or 5G beyond for example, an upcoming sixth-generation (6G) wireless communication technology, a sidelink communication (or a device-to-device communication) may take place among multiple user devices when the multiple user devices are synchronized with each other. The multiple user devices are synchronized by transmission of synchronization signal based on a common synchronization source. The transmission of synchronization signal includes transmission of either sidelink synchronization signals (SLSS) or sidelink synchronization signal block (S-SSB).

Generally, in a new radio (NR) vehicle-to-everything (V2X) sidelink communication network, there are four types of synchronization sources (or references) which include: a base station (e.g. an evolved NodeB (eNB) or a next-generation NodeB (gNB)), a global navigation satellite system (GNSS), synchronization reference (SyncRef) user device or user device's (UD's) own internal clock.

Conventionally, a user device selects (or reselects) its synchronization source in accordance with pre-determined rules that are based on priorities and measurements of different synchronization sources. Regarding the priorities, for example, the base station (BS) or the GNSS may have higher priority than a SyncRef user device or a UD's internal clock.

In an NR V2X sidelink communication network, there are certain scenarios in which conventional user device can be triggered to become a SyncRef user device for transmitting the synchronization signal (i.e. the sidelink synchronization signals (SLSS) or the sidelink synchronization signal block (S-SSB)). In an example, when the conventional user device lies in a network coverage of a serving base station (or a reference cell), then the conventional user device is configured by the serving base station to become a SyncRef user device or not.

In a case, when the conventional user device lies in the network coverage of the serving base station but the conventional user device is not configured to become a SyncRef user device or not then in such a case, the conventional user device transmits the synchronization signal (or the conventional user device becomes the SyncRef user device) only if a reference signal received power (RSRP) measurement of the serving base station is below a configured threshold value. In this way, the conventional user device determines based on measurements (i.e. RSRP) of the serving base station whether it (i.e. the conventional user device) becomes a SyncRef user device or not.

In another example, when the conventional user device lies out of the network coverage of the serving base station, then the conventional user device either selects the GNSS or its internal clock as its synchronization source (SyncRef) to transmit the synchronization signal. In addition, when the conventional user device is out of the network coverage of the serving base station, then the conventional user device can also select another SyncRef user device (i.e., another conventional user device acting as a synchronization source by transmitting the synchronization signal) as its synchronization source.

In case of selection of the other SyncRef user device, the conventional user device transmits the synchronization signal only if a RSRP measurement of the other SyncRef user device is below a pre-configured threshold value. Thus, based on the RSRP measurements of the other SyncRef user device, the conventional user device determines whether it becomes a SyncRef user device or not.

Further, the transmission of synchronization signal by a SyncRef user device enables to expand the synchronization coverage of the SyncRef user device's synchronization source (e.g. the network of the serving base station, the GNSS, the other SyncRef user device, or its internal clock).

Moreover, when a conventional user device has been triggered to become a SyncRef user device, the SyncRef user device transmits the synchronization signal (i.e. the sidelink synchronization signal block (S-SSB)) with a transmsission power, which is based on the synchronization signal power control. In an example, in the NR V2X sidelink communication network, the SyncRef user device which is in network coverage of the serving BS, is configured to transmit the synchronization signal with a power control based on a downlink (DL) pathloss (PL) of the serving BS.

The conventional transmission of synchronization signal on sidelink may not be optimal if the complicated scenarios are considered in the future.

### SUMMARY

The present disclosure seeks to provide a user device and a method that provides an improved (with reduced power) transmission of synchronization signal in a sidelink communication network. The user device may be referred as user equipment (UE). The present disclosure seeks to provide a solution to the existing problem of high power transmission of synchronization signal in a sidelink communication network. An aim of the present disclosure is to provide a user equipment and a method that provides an improved (with reduced power) transmission of synchronization signal in the sidelink communication network.

The object of the present disclosure is achieved by the solutions provided in the enclosed independent claims. Advantageous implementations of the present disclosure are further defined in the dependent claims.

In an aspect, the present disclosure provides user equipment (UE), arranged to operate sidelink communication. The UE comprises a transceiver that is configured to receive a first signal from a first synchronization source. The UE may further comprise a processor that is configured to obtain a set of sidelink synchronization signal (SLSS), identifiers (IDs). The processor may be further configured to operate power control of transmission of a synchronization signal based on the first signal and the set of SLSS IDs.

The discosed user equipment (UE) may be configured to consider nearby synchronization sources such as nearby base stations or nearby synchronization reference (SyncRef) user devices to operate the power control of synchronization signal transmsission in a sidelink communication network. This results into a reduced power consumption and hence, an improved energy efficiency of the disclosed UE.

In an implementation form, the processor may be further configured to obtain the set of sidelink synchronization signal (SLSS), identifiers (IDs) by receiving a set of SLSS IDs from a serving base station (BS).

The received set of SLSS IDs from the serving base station (BS) may include the SLSS IDs used by SyncRef UEs in nearby cells. The consideration of SyncRef UEs in nearby cells for the power control of synchronization signal transmsission of the UE allows an efficient expansion of synchronization coverage of the UE.

In a further implementation form, the processor may be further configured to obtain the set of sidelink synchronization signal (SLSS), identifiers (IDs) by receiving a set of SLSS IDs from a synchronization reference (SyncRef), UE.

It is advantageous to receive the set of SLSS IDs from the SyncRef UE because it avoids a transmission of synchronization signal (e.g. sidelink synchronization signal block (S-SSB)) of the UE with a maximum transmit power. The SyncRef UE allows a further reduced power consumption and hence, an improved energy efficiency of the UE.

In a further implementation form, the processor may be further configured to obtain the set of sidelink synchronization signal (SLSS) identifiers (IDs) by determining the set of SLSS IDs based on an SLSS ID of a synchronization reference (SyncRef), UE and rules of pre-configuration.

By virtue of using the rules of pre-configuration, the set of SLSS IDs of the UE can be preconfigured depending on the synchronization source of the UE.

In a further implementation form, the set of SLSS IDs may be determined to include the SLSS ID used by the synchronization reference (SyncRef), UE.

The inclusion of the SLSS ID used by the SyncRef UE enables the UE to determine which of the nearby SyncRef UEs are considered for power control of the synchronization signal transmission.

In a further implementation form, the processor may be further configured to obtain a priority of the synchronization reference (SyncRef), UE. The processor may be further configured to include the SLSS ID of the synchronization reference (SyncRef), UE in the set of SLSS IDs when the priority of the synchronization reference (SyncRef), UE is higher than or equal to the priority of the User Equipment.

The inclusion of the SLSS ID of the SyncRef UE, that manifests higher than or equal to the priority of the User Equipment, in the set of SLSS IDs of the UE enables a further reduction in power consumption of the UE and an efficient expansion of synchronization coverage of the UE, as well.

In a further implementation form, the transceiver may be enabled for beamforming wherein the first signal may be received on a first beam. The processor may be further configured to operate the power level for transmitting the synchronization signal on the first beam.

In case of beamforming at the UE, the measurement of the first synchronization source may be performed per beam (such as the first beam), which enables a beam-based synchronization signal power control of the UE. This further improves the efficiency of the synchronization coverage expansion, as the power control of the synchronization signal transmissions can be done in a spatially selective way by considering the nearby synchronization sources.

In a further implementation form, the first synchronization source may be a Base Station (BS), and wherein the processor is further configured to operate the power control based on a DownLink PathLoss (DL PL), of the first signal.

It is advantageous to operate the S-SSB power control of the UE based on the DL PL of the base station, to reduce a potential interference that may be caused by the UE to the nearby base stations, which are synchronized with the base station. This further results into an efficient expansion of synchronization coverage of the UE.

In a further implementation form, the first synchronization source may be a synchronization reference (SyncRef), user equipment (UE), and wherein the processor may be further configured to operate the power control based on a Reference Signal Received Power (RSRP) of the first signal.

It is advantageous to consider the RSRP measurement of the SyncRef UE for the S-SSB power control of the UE because it enables to adjust the S-SSB transmit power of the UE depending on its radio proximity to the SyncRef UE and on the existing synchronization coverage provided by the SyncRef UE.

In a further implementation form, the processor may be further configured to compare the Reference Signal Received Power (RSRP) of the first signal with a threshold value and operate the power control based on the comparison.

Based on the comparison of the RSRP of the first signal with the threshold value, the UE can determine whether the UE is close to another SyncRef UE and based on this the UE can determine the power level of the synchronization signal transmission.

In a further implementation form, the processor may be further configured to determine the power level of a data transmission. The processor may be further configured to operate the power control based on the power level of the data transmission when the UE is transmitting data.

The consideration of the power level associated with the data transmission of the UE for the S-SSB power control of the UE, enables the UE to have a larger synchronization coverage compared to the coverage of the data transmission.

In a further implementation form, the processor may be further configured to operate the power control based on the power level of the data transmission and a pre-specified offset value.

The computation of the S-SSB power control of the UE based on the power level associated with the data transmission and the pre-specified offset value leads to a more efficient synchronization coverage expansion of the UE.

In a further implementation form, the first signal may be received from the first synchronization source having a first sidelink synchronization signal (SLSS) identifier (ID). The processor may be further configured to operate power control of transmission of a synchronization signal based on the first signal and the set of SLSS IDs by determining when the first SLSS ID is within the set of SLSS IDs.

By determining the first SLSS ID within the set of SLSS IDs of the UE, the S-SSB power control of the UE can be performed in a more efficient way by considering the received power associated with other sidelink transmissions such as those from the first synchronization source.

In a further implementation form, the User Equipment may be arranged for acting as a Synchronization Reference UE (SyncRef UE) in a sidelink communication network.

By transmitting synchronization signal, the UE may act as a SyncRef UE, which is beneficial for synchronization coverage expansion of the UE.

In another aspect, the present disclosure provides a method for operating sidelink communication in a User Equipment (UE), wherein the method comprises receiving a first signal from a first synchronization source. The method may further comprise obtaining a set of sidelink synchronization signal (SLSS), identifiers (IDs). The method may further comprise operating power control of transmission via the transceiver of a synchronization signal based on the first signal and the set of SLSS IDs.

By virtue of using the method for operating sidelink communication in the UE, the transmission of the synchronization signal with a large transmit power is avoided and hence, results into an improved energy efficiency as well as an improved synchronization coverage expansion of the UE.

In a yet another aspect, the present disclosure provides a computer-readable medium carrying computer instructions that when loaded into and executed by a processor of a User Equipment enables the User Equipment to implement the method.

By virtue of loading computer instructions into the processor, the processor may be configured to implement and execute the method of operating power control of transmission of a synchronization signal based on the first signal and the set of SLSS IDs.

It is to be appreciated that all the aforementioned implementation forms can be combined.

It has to be noted that all devices, elements, circuitry, units and means described in the present application could be implemented in the software or hardware elements or any kind of combination thereof.

All steps which are performed by the various entities described in the present application as well as the functionalities described to be performed by the various entities are intended to mean that the respective entity is adapted to or configured to perform the respective steps and functionalities. Even if, in the following description of specific embodiments, a specific functionality or step to be performed by external entities is not reflected in the description of a specific detailed element of that entity which performs that specific step or functionality, it should be clear for a skilled person that these methods and functionalities can be implemented in respective software or hardware elements, or any kind of combination thereof.

It will be appreciated that features of the present disclosure are susceptible to being combined in various combinations without departing from the scope of the present disclosure as defined by the appended claims.

Additional aspects, advantages, features and objects of the present disclosure would be made apparent from the drawings and the detailed description of the illustrative implementations construed in conjunction with the appended claims that follow.

### BRIEF DESCRIPTION OF THE DRAWINGS

The summary above, as well as the following detailed description of illustrative embodiments, is better understood when read in conjunction with the appended drawings. For the purpose of illustrating the present disclosure, exemplary constructions of the disclosure are shown in the drawings. However, the present disclosure is not limited to specific methods and instrumentalities disclosed herein. Moreover, those in the art will understand that the drawings are not to scale. Wherever possible, like elements have been indicated by identical numbers.

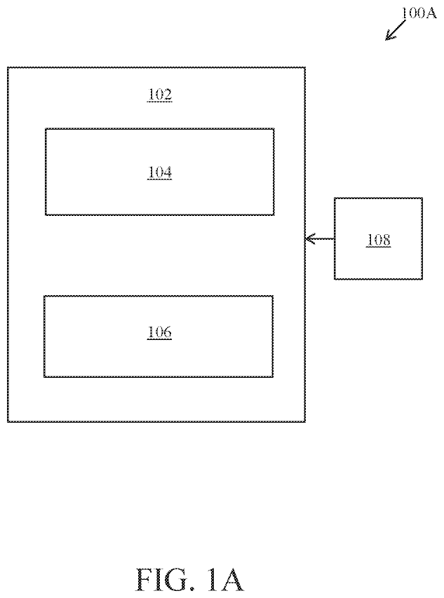

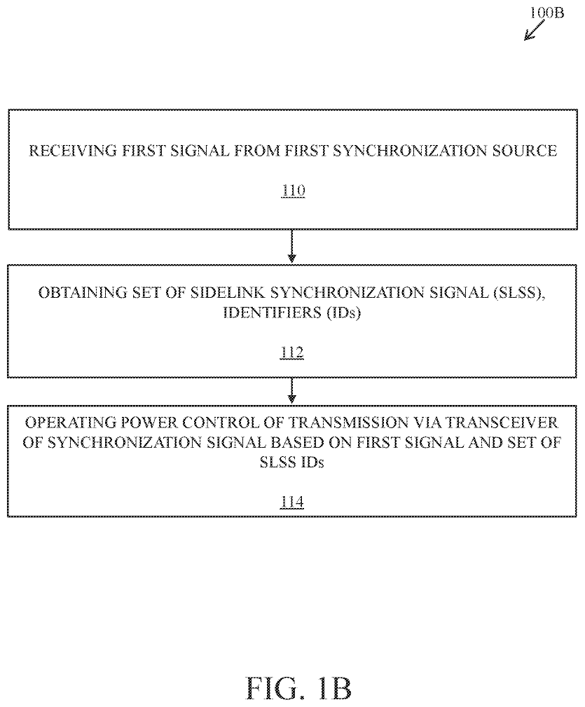

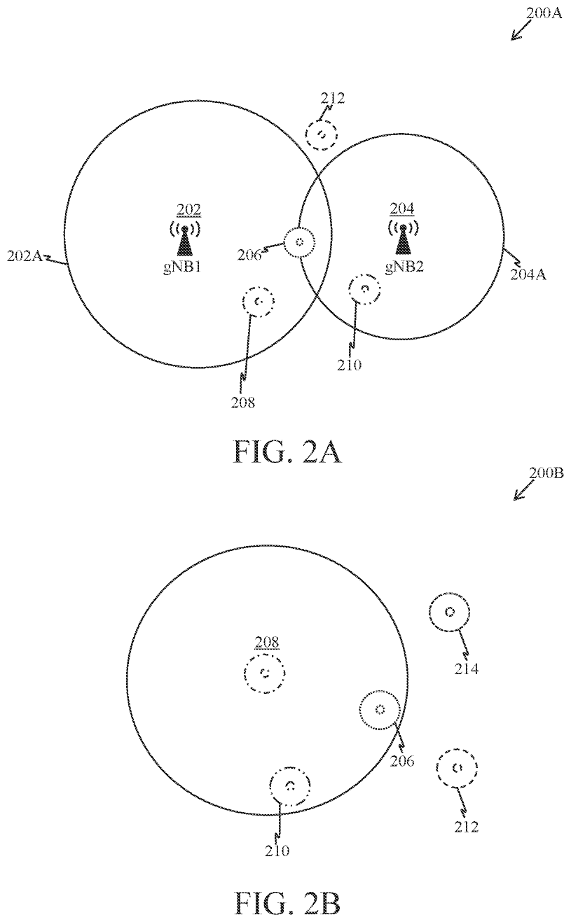

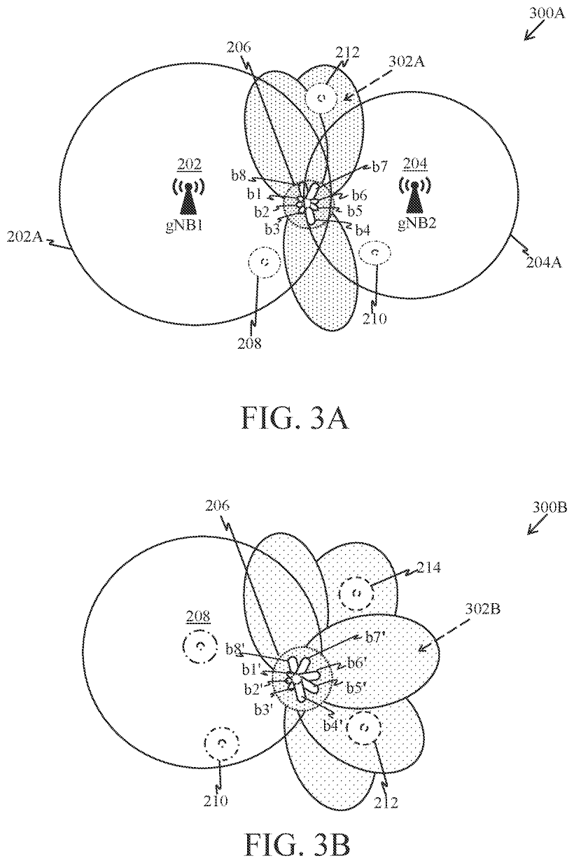

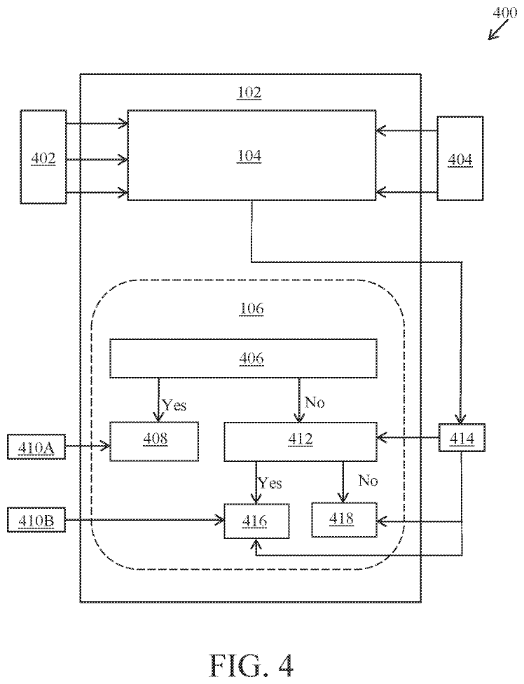

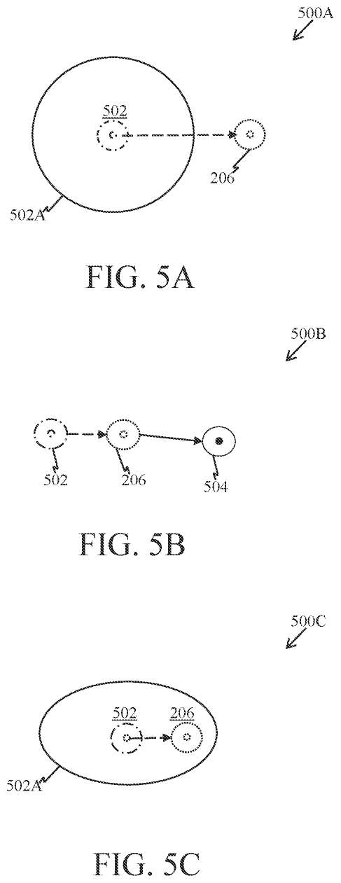

Embodiments of the present disclosure will now be described, by way of example only, with reference to the following diagrams wherein:
a. FIG. 1A is a block diagram that illustrates various exemplary components of a user equipment, in accordance with an embodiment of the present disclosure;
b. FIG. 1B is a flowchart of a method for operating sidelink communication in the user equipment, in accordance with an embodiment of the present disclosure;
c. FIG. 2A is a schematic representation of synchronization signal (i.e. sidelink synchronization signal block (S-SSB)) power control of the user equipment (UE) when lies in network coverage of a base station, in accordance with an embodiment of the present disclosure;
d. FIG. 2B is a schematic representation of S-SSB power control of the user equipment (UE) when lies outside of network coverage of a base station, in accordance with an embodiment of the present disclosure;
e. FIG. 3A is a schematic representation of a beam based S-SSB power control of the user equipment (UE) when lies in network coverage of a base station, in accordance with an embodiment of the present disclosure;
f. FIG. 3B is a schematic representation of a beam based S-SSB power control of the user equipment (UE) when lies out of network coverage of a base station, in accordance with an embodiment of the present disclosure;
g. FIG. 4 is a flowchart of a method of S-SSB power control of the user equipment in accordance with another embodiment of the present disclosure;
h. FIG. 5A is an exemplary implementation of S-SSB power control of the first SyncRef UE in accordance with an embodiment of the present disclosure;
i. FIG. 5B is an exemplary implementation of S-SSB power control of the first SyncRef UE when the first SyncRef UE is transmitting data, in accordance with an embodiment of the present disclosure; and
j. FIG. 5C is an exemplary implementation of S-SSB power control of the first SyncRef UE when the first SyncRef UE is not transmitting data, in accordance with an embodiment of the present disclosure.

In the accompanying drawings, an underlined number is employed to represent an item over which the underlined number is positioned or an item to which the underlined number is adjacent. A non-underlined number relates to an item identified by a line linking the non-underlined number to the item. When a number is non-underlined and accompanied by an associated arrow, the non-underlined number is used to identify a general item at which the arrow is pointing.

### DETAILED DESCRIPTION OF EMBODIMENTS

The following detailed description illustrates embodiments of the present disclosure and ways in which they can be implemented. Although some modes of carrying out the present disclosure have been disclosed, those skilled in the art would recognize that other embodiments for carrying out or practicing the present disclosure are also possible.

In this application, the user device may also be referred to as user equipment or a wireless communications device. Examples of the user device may include, but are not limited to, a communication device, a mobile device, an automatic vehicle, a semi-automatic vehicles, a vehicle, a robot, or other portable or non-portable communication device, and the like. User equipment (UE) may be used instead of user device in this application. It should be understood that UE and user device will be used without differentiation, for example, SyncRef user device will be referred as SyncRef UE. Moreover, in the present disclsoure, “higher than or equal to” may include one of: higher than, equal to, or equal and higher than.

As described in the background, when the SyncRef UE is in the network coverage of the serving BS, then the DL PL of the serving base station can be considered for the synchronization signal power control to avoid interference to the serving BS (e.g. a next-generation NodeB).

In another example, when the SyncRef UE lies out of the network coverage of the serving BS, then the SyncRef UE transmits the synchronization signal (where the synchronization signal can comprise the synchronization information) with a pre-configured maximum transmit power. In this way, the synchronization signal power control of the SyncRef UE (which is either in or out of the network coverage) does not take into account the transmissions of other nearby synchronization sources (i.e. nearby base stations or nearby SyncRef UEs).

Due to presence of nearby synchronization sources, the SyncRef UE transmitting the synchronization signal with high transmit power (e.g. when out of the network coverage or at the cell edge when in the network coverage) may lead to a large overlap with the synchronization coverage of existing synchronization (sync) sources (e.g. other nearby SyncRef UEs).

Although the high power transmission of the synchronization signal results in a larger synchronization coverage expansion, however, this may also result in the larger overlap with the synchronization coverage of the existing synchronization (sync) sources (e.g. other nearby SyncRef UEs).

Therefore, there exists a tradeoff between the sync coverage expansion (i.e. transmitting power of synchronization signal of the new SyncRef UE) and the overlap with the coverage provided by the existing sync sources. The conventional ways of power control in NR V2X sidelink communication network do not consider this tradeoff.

Furthermore, when the SyncRef UE is in the network coverage of the serving BS, then the synchronization signal transmissions of the SyncRef UE can avoid interference to its serving BS, yet there can be interference to an uplink transmission of a nearby BS.

As the transmission power of the BS (or the nearby BS) is a deployment choice, the nearby BS may be transmitting at a lower power than the serving BS, such that the DL PL to the nearby BS may be smaller than the DL PL to the serving BS. Hence, the nearby BS may experience interference from the SyncRef UE.

Therefore, in addition to interference, the synchronization signal transmissions at high power by the SyncRef UE close to the nearby BS may lead to a large overlap with the existing coverage of the nearby BS, similar to when there are other nearby SyncRef UEs. Thus, there exists a technical problem of high power transmission of synchronization signal in a sidelink communication network.

Therefore, in light of the foregoing discussion, there exists a need to overcome the aforementioned drawbacks associated with the conventional user equipment and various ways used for operating sidelink communication.

FIG. 1A is a block diagram that illustrates various exemplary components of a user equipment, in accordance with an embodiment of the present disclosure. With reference to FIG. 1A, there is shown a block diagram 100A of a user equipment (UE) 102 that comprises a transceiver 104 and a processor 106. There is further shown a first synchronization source 108.

The UE 102 is arranged to operate sidelink communication with another UE (or device). The UE 102 may also be referred to as a wireless communications device. Examples of the UE 102 may include, but are not limited to, a communication device, a mobile device, an automatic vehicle, a semi-automatic vehicles, a vehicle, a robot, or other portable or non-portable communication device, and the like. FIG. 1A is described by taking an example of the UE 102, however, it is to be understood by a person of ordinary skill in the art that a plurality of UEs may be operational or used in practice, without limiting the scope of the disclosure.

The transceiver 104 may be configured to receive a first signal from the first synchronization source 108. Examples of the transceiver 104 may include, but is not limited to, a radio frequency transceiver, a network interface, a telematics unit, or any other antenna suitable for use in the UE 102, a WLAN-enabled device, such as an access point device, a smart phone, an Internet-of-Things (IoT) device, or other portable or non-portable communication device. The transceiver 104 supports various wireless communication protocols to execute wireless communication.

The processor 106 may comprise suitable logic, circuitry, interfaces, and/or code that is configured to obtain a set of sidelink synchronization signals (SLSS), identifiers (IDs). Examples of the processor 106 may include, but is not limited to, a co-processor, a microprocessor, a microcontroller, a complex instruction set computing (CISC) processor, an application-specific integrated circuit (ASIC) processor, a reduced instruction set (RISC) processor, a very long instruction word (VLIW) processor, a central processing unit (CPU), a state machine, a data processing unit, and other processors or circuits. Moreover, the processor 106 may refer to one or more individual processors, processing devices, a processing unit that is part of the UE 102.

The first synchronization source 108 may be configured to transmit the first signal to the transceiver 104 of the UE 102. Examples of the first synchronization source 108 may include, but are not limited to, a base station (i.e. an evolved NodeB (eNB) or a next generation NodeBs (gNB)), or a synchronization reference (SyncRef) UE. The first synchronization source 108 may also be referred to as a first synchronization reference (SyncRef).

In operation, the UE 102 may be arranged to operate sidelink communication. The UE 102 may include the transceiver 104 which may be configured to receive the first signal from the first synchronization source 108. The processor 106 may be configured to obtain the set of sidelink synchronization signal (SLSS) identifiers (IDs) and operate power control of transmission of a synchronization signal based on the first signal and the set of SLSS IDs.

The UE 102 may be arranged to operate sidelink communication with another UE (or a communication device) without relaying on an intermediary network. The UE 102 may transmit synchronization signal to the other UE (or the communication device).

The synchronization signal may include sidelink synchronization signals (SLSS) or sidelink synchronization signal block (S-SSB). The sidelink synchronization signals (SLSS) may include a sidelink primary synchronization signal (PSS) and a sidelink secondary synchronization signal (SSS). The sidelink synchronization signal block (S-SSB) may include the SLSS (i.e. the sidelink PSS and the sidelink SSS), as well as timing signal, additional configuration parameters, and additional signals.

The UE 102 may be configured with a set of cell IDs (when lies in the network coverage of a base station) or a set of resources (e.g., when having other SyncRef UEs as synchronization source) also. The transmission of synchronization signal from the UE 102 to the other UE (or the communication device) consumes a power of the UE 102 which can be controlled on the basis of the received first signal and the obtained set of SLSS IDs. The first signal is received from certain nearby synchronization sources such as the first synchronization source 108.

In an example, the first synchronization source 108 may be a base station and the UE 102 may lay in the network coverage of the base station. Therefore, the received first signal includes a cell ID of the base station. The cell ID of the base station corresponds to a cell ID among the configured set of cell IDs of the UE 102. Therefore, the power control of synchronization signal transmission of the UE 102 depends on measurements (e.g. downlink path loss (DL PL)) of the base station.

In another example, the first synchronization source 108 may be a synchronization reference (SyncRef) UE which may have same timing and same or higher priority as the UE 102. In such a case, the received first signal may include a SLSS ID and/or a resource (e.g. time or frequency) on which the SyncRef UE is transmitting the synchronization signal. The SLSS ID of the SyncRef UE corresponds to a SLSS ID among the obtained set of SLSS IDs of the UE 102.

Similarly, the resource of the SyncRef UE corresponds to a resource among the configured set of resources of the UE 102. Therefore, the power control of synchronization signal transmission of the UE 102 depends on measurements (e.g. reference signal received power (RSRP)) of the SyncRef UE. If there is a change in situation then the power control of synchronization signal transmission of the UE 102 may be updated based on new measurements of the base station as well as the SyncRef UE.

In accordance with an embodiment, the processor 106 is further configured to obtain the set of sidelink synchronization signal (SLSS), identifiers (IDs) by receiving a set of SLSS IDs from a serving base station, BS.

In an implementation, the UE 102 may lay in network coverage of the serving base station. Therefore, the obtained set of SLSS IDs of the UE 102 may also include a SLSS ID that is used by SyncRef UEs in the network coverage of the serving base station. The UE 102 may be configured to use the SLSS ID of the serving base station, since the UE 102 lies in the network coverage of the serving base station.

The obtained set of SLSS IDs may also include the SLSS IDs of nearby SyncRef UEs, e.g., which lie in the coverage of nearby base stations that are synchronized with the serving base station. The serving base station can signal (or transmit) the set of SLSS IDs to the UE 102 and other UEs (i.e. a plurality of UEs in practice) that lies within the network coverage of the serving base station.

In accordance with an embodiment, the processor 106 may be further configured to obtain the set of sidelink synchronization signal (SLSS), identifiers (IDs) by receiving a set of SLSS IDs from a synchronization reference (SyncRef), UE.

In an implementation, the UE 102 may select the SyncRef UE (e.g. another SyncRef UE) as its synchronization source and the SyncRef UE lies either in the network coverage of a serving base station or out of the network coverage of a base station. The SyncRef UE may be configured to signal (or transmit) the set of SLSS IDs to the UE 102.

In accordance with an embodiment, the processor 106 may be further configured to obtain the set of sidelink synchronization signal (SLSS), identifiers (IDs) by determining the set of SLSS IDs based on an SLSS ID of a synchronization reference (SyncRef) UE and rules of pre-configuration. The rules of pre-configuration may be used to determine a pre-configured set of SLSS IDs, and a pre-configured set of resources (i.e. time and frequency) for the UE 102.

For example, in a case, if the UE 102 selects the SyncRef UE as its synchronization source, the set of SLSS IDs of the UE 102 may be determined based on the SLSS ID of the SyncRef UE. Additionally, the (pre-)configured set of resources of the UE 102 can be determined based on a (pre-)configured set of resources associated with synchronization signal (i.e. S-SSB) transmission of the SyncRef UE.

In another case, if the synchronization source of the UE 102 is a GNSS, then, the (pre-)configured set of resources of UE 102 can be determined based on a (pre-) configured set of resources associated with the GNSS.

In a yet another case, if the synchronization source of the UE 102 is its own internal clock then the set of SLSS IDs of the UE 102 can be preconfigured: (1) to be empty if not any synchronization source is detectable (out of the network coverage of a base station), (2) by the base station as an empty set, or (3) based on the SLSS IDs associated with the GNSS. In such a case, the power control of synchronization signal transmission of the UE 102 depend on the SyncRef UE and also on other parameters or features (such as preconfiguration rules) which are used when the UE 102 is configured to operate in a default mode.

In accordance with an embodiment, the set of SLSS IDs may be determined to include the SLSS ID used by the synchronization reference (SyncRef), UE. The UE 102 may select the SyncRef UE as its synchronization source, therefore, the set of SLSS IDs of the UE 102 may be configured to include the SLSS ID of the SyncRef UE.

In accordance with an embodiment, the processor 106 may be further configured to obtain a priority of the synchronization reference (SyncRef), UE. The processor 106 may be further configured to include the SLSS ID of the synchronization reference (SyncRef) UE in the set of SLSS IDs when the priority of the synchronization reference (SyncRef) UE is higher than or equal to the priority of the UE 102. The processor 106 of the UE 102 may be configured to determine the priority of the SyncRef UE. If the SyncRef UE provides the same timing (that is, the transmission of synchronization signal is performed on certain resources) and same (equal) or higher priority as that of the UE 102, then the set of SLSS IDs of the UE 102 is configured to include the SLSS ID of the SyncRef UE plus 336.

In accordance with an embodiment, the transceiver 104 may be enabled for beamforming wherein the first signal may be received on a first beam. The processor 106 may be further configured to operate the power level for transmitting the synchronization signal on the first beam.

The transceiver 104 may be configured to receive the first signal from the first synchronization source 108 on the first beam. In case of beamforming at the UE 102, the measurements of other synchronization sources may be performed per beam which enables the beam based synchronization signal (i.e. S-SSB) power control of the UE 102.

Therefore, the power control of synchronization signal transmission within the first beam of the UE 102 may be determined only by the measurements of a subset of other synchronization sources (such as the first synchronization source 108). For example, the first synchronization source 108 lies near to the UE 102. The first synchronization source 108 may only impact the transmission power of the synchronization signals sent by the UE 102 only on the beams (i.e. directions) which are towards the first synchronization source 108. The first synchronization source 108 may not impact the transmitting (Tx) power of the synchronization signals sent by the UE 102 on the beams, those not pointing towards the first synchronization source 108.

In accordance with an embodiment, the first synchronization source 108 may be a Base Station (BS), and wherein the processor 106 may be further configured to operate the power control based on a DownLink PathLoss (DL PL), of the first signal.

In an implementation, the first synchronization source 108 may be the Base Station (BS) and the received first signal may include the DL PL of the base station. Therefore, the power control of synchronization signal transmission of the UE 102 depends on the DL PL of the base station. In such implementation, the UE 102 may be configured with a set of cell IDs of the base stations that should be considered for the power control of synchronization signal transmission of the UE 102. The DL PL of the base station can be derived based on a measured RSRP of the base station and a transmission (Tx) power (i.e. broadcasted by the base station). Measurements of the DL PL of the nearby base stations may be already performed in new radio (NR), e.g. for neighbor cell report.

In accordance with an embodiment, the first synchronization source 108 may be a synchronization reference (SyncRef) user equipment (UE), and wherein the processor 106 may be further configured to operate the power control based on a Reference Signal Received Power (RSRP) of the first signal.

In an implementation, the first synchronization source 108 may be the SyncRef UE and the received first signal may include the RSRP of the SyncRef UE. Therefore, the power control of synchronization signal transmission of the UE 102 depends on the RSRP of the SyncRef UE. The RSRP of the SyncRef UE is measured based on reference signals, for example, demodulation reference signals (DMRS) which are transmitted by the SyncRef UE along with the synchronization signal transmission.

The use of the RSRP of the SyncRef UE for the synchronization signal power control of the UE 102 allows a reduced power consumption and improved energy efficiency of the UE 102, for example, by avoiding transmission of the synchronization signal with a high tranmsmit power. The RSRP measurement of the SyncRef UE is already performed in new radio (NR) vehicle-to-everything (V2X) for procedures, such as (re)selection of synchronization references.

Additionally, the RSRP measurement of the SyncRef UE may be used to control the synchronization signal (i.e. S-SSB) transmission power depending on a radio proximity and on an existing synchronization coverage provided by the SyncRef UE.

In accordance with an embodiment, the processor 106 may be further configured to compare the Reference Signal Received Power (RSRP) of the first signal with a threshold value and operate the power control based on the comparison. The RSRP of the SyncRef UE received in the first signal may be compared with the threshold value at the UE 102. If the RSRP of the SyncRef UE is above the threshold value then, the UE 102 is configured to consider this SyncRef UE for determining the power level of the synchronization signal transmission.

In accordance with an embodiment, the processor 106 may be further configured to determine the power level of a data transmission and operate the power control based on the power level of the data transmission when the User Equipment 102 is transmitting data. In other words, when the UE 102 is transmitting data, then the synchronization signal power control of the UE 102 is based on the transmit power of the data transmission and a pre-configured data (or sync) offset between the transmit power of the data transmissions and the transmit power of the synchronization signal (i.e. S-SSB).

In accordance with an embodiment, the processor 106 may be further configured to operate the power control based on the power level of the data transmission and a pre-specified offset value. For example, in a case, the UE 102 is transmitting data to a receive UE then, the S-SSB power control of the UE 102 may be based on the power level associated with the data transmission and the pre-configured offset value. The pre-configured offset value corresponds to a power offset value between the transmit power of the data transmissions and the transmit power of the synchronization signal.

In accordance with an embodiment, the first signal may be received from the first synchronization source 108 having a first sidelink synchronization signal (SLSS), identifier (ID). The processor 106 may be configured to operate power control of transmission of a synchronization signal based on the first signal and the set of the SLSS IDs by determining when the first SLSS ID is within the set of SLSS IDs. The UE 102 may receive the first signal from the first synchronization source 108 (e.g. the SyncRef UE), and the received first signal may include the first SLSS ID of the first synchronization source 108. If the first SLSS ID of the first synchronization source 108 lies within the set of SLSS IDs of the UE 102, then the power control of synchronization signal transmission of the UE 102 depends on a RSRP between the UE 102 and the first synchronization source 108.

In NR V2X, the sidelink pathloss between the UE 102 (e.g. receive UE) and the first synchronization source 108 (e.g. transmit UE) can not be derived at the UE 102. The reason is, the first synchronization source 108 does not indicate its transmission (Tx) power to the UE 102, in NR V2X (in contrast to a base station which indicates its Tx power for DL PL derivation at the UE 102).

Thus, the UE 102 may be configured to consider nearby synchronization sources such as nearby base stations or nearby synchronization reference (SyncRef) user equipments (UEs) to operate the power control of synchronization signal transmsission in a sidelink communication network. This results into a reduced power consumption and hence, an improved energy efficiency of the UE 102.

The consideration of the nearby base stations for the power control of synchronization signal transmsission of the UE 102 allows to reduce a potential interference that may be caused by the UE 102 to the nearby base stations, which are synchronized with the serving base station. This further results into an efficient expansion of synchronization coverage of the UE 102. The selection of the SyncRef UE as a synchronization source of the UE 102 (when lies out of the network coverage) avoids a transmission of synchronization signal (e.g. sidelink synchronization signal block (S-SSB)) of the UE 102 with a maximum transmit power. Therefore, the SyncRef UE allows a further reduced power consumption and hence, an improved energy efficiency of the UE 102.

FIG. 1B is a flowchart of a method for operating sidelink communication in the user equipment, in accordance with an embodiment of the present disclosure. FIG. 1B is described in conjunction with elements from FIG. 1A. With reference to FIG. 1B, there is shown a method 100B for operating the sidelink communication in the UE 102. The method 100B may include steps 110, 112, and 114. The method 100B may be executed by the UE 102 (of FIG. 1A).

At step 110, the method 100B may comprise receiving a first signal from a first synchronization source (such as the first synchronization source 108). In an example, the first synchronization source (i.e. the first synchronization source 108) may be a base station, and the received first signal includes a cell ID of the base station.

In another example, the first synchronization source (i.e. the first synchronization source 108) may be a synchronization reference (SyncRef) UE, and the received first signal includes a SLSS ID and a resource (i.e. time and frequency values) for S-SSB transmission of the SyncRef UE. The transceiver 104 of the UE 102 may be configured to receive the first signal from the first synchronization source (such as the first synchronization source 108).

At step 112, the method 100B may further comprise obtaining a set of sidelink synchronization signal (SLSS), identifiers (IDs). The obtained set of SLSS IDs may include a (pre-) configured set of SLSS IDs. The SLSS ID of the SyncRef UE may be compared with the obtained set of SLSS IDs. If the SLSS ID of the SyncRef UE lies within the obtained set of SLSS IDs, then, the SyncRef UE is considered for S-SSB power control of the UE 102. The processor 106 of the UE 102 is configured to obtain the set of SLSS IDs.

At step 114, the method 100B may further comprise operating power control of transmission via the transceiver 104 of a synchronization signal based on the first signal and the set of SLSS IDs.

In a case, the first synchronization source 108 may be a synchronization reference (SyncRef) UE which may have same timing and same or higher priority as the UE 102. In such a case, the received first signal may include a SLSS ID and/or a resource (e.g. time or frequency) on which the SyncRef UE is transmitting the synchronization signal. The SLSS ID of the SyncRef UE corresponds to a SLSS ID among the obtained set of SLSS IDs of the UE 102. Therefore, the power control of synchronization signal transmission of the UE 102 depends on measurements (e.g. reference signal received power (RSRP)) of the SyncRef UE.

In accordance with an embodiment, a computer-readable medium carrying computer instructions that when loaded into and executed by the processor 106 of the user equipment 102 enables the UE 102 to implement the method 100B. In other words, the method 100B is executed by the processor 106 of the UE 102 by using a computer-readable medium carrying computer instructions.

The steps 110, 112, and 114 are only illustrative and other alternatives can also be provided where one or more steps are added, one or more steps are removed, or one or more steps are provided in a different sequence without departing from the scope of the claims herein.

FIG. 2A is a schematic representation of synchronization signal (i.e. sidelink synchronization signal block (S-SSB)) power control of the user equipment (UE) when lies in the network coverage of a base station, in accordance with an embodiment of the present disclosure. FIG. 2A is described in conjunction with elements from FIGS. 1A and 1B. With reference to FIG. 2A, there is shown a schematic representation 200A that may include a first base station 202, a second base station 204, a first SyncRef UE 206, and a plurality of other SyncRef UEs, such a second SyncRef UE 208, a third SyncRef UE 210, and a fourth SyncRef UE 212. The network coverage of the first base station 202 and the second base station 204 is represented by 202A and 204A, respectively.

The UE 102 (of FIG. 1A) lies within the network coverage 202A of the first base station 202 (also represented as gNB1), and at an edge of the network coverage 204A of the second base station 204. Therefore, the first base station 202 may be also termed as a serving base station of the user equipment 102.

The UE 102 is triggered to become the first SyncRef UE 206 to transmit the synchronization signal (i.e. S-SSB). Therefore, the UE 102 is hereafter referred as the first SyncRef UE 206. The first base station 202 (i.e. gNB1) and the second base station 204 (also represented as gNB2), both are synchronized.

Before the first SyncRef UE 206 is triggered to transmit the synchronization signal (i.e. S-SSB), the plurality of other SyncRef UEs, such as the second SyncRef UE 208, the third SyncRef UE 210, and the fourth SyncRef UE 212 have previously been triggered to send S-SSBs. The plurality of other SyncRef UEs, such as the second SyncRef UE 208, the third SyncRef UE 210, and the fourth SyncRef UE 212 correspond to nearby synchronization sources of the first SyncRef UE 206. The second SyncRef UE 208 lies within the network coverage 202A (or cell) of the first base station 202 (i.e. gNB1), the third SyncRef UE 210 lies within the network coverage 204A (or cell) of the second base station 204 (i.e. gNB2) and the fourth SyncRef UE 212 lies out of the network coverage of the first base station 202 as well as of the second base station 204.

For synchronization signal (i.e. S-SSB) power control of the first SyncRef UE 206, the first SyncRef UE 206 may be configured by the first base station 202 (i.e. gNB1) to consider the second SyncRef UE 208. The second SyncRef UE 208 manifests a SLSS ID (e.g. SLSS ID X), where X corresponds to a SLSS ID used by one or more SyncRef UEs, those lies within the network coverage 202A of the first base station 202 (i.e. gNB1)). Moreover, the second base station 204 (i.e. gNB2) can also transmit the SLSS ID that is used by SyncRef UEs in the network coverage 204A of the second base station 204.

The second base station can indicate the SLSS ID Y to the first base station 202 (i.e. gNB1), where Y corresponds to a SLSS ID used by one or more SyncRef UEs, those lies within the network coverage 204A of the second base station 204 (i.e. gNB2).

The third SyncRef UE 210 manifests a SLSS ID (e.g. SLSS ID Y). For synchronization signal (i.e. S-SSB) power control, the first SyncRef UE 206 may be configured to consider SyncRef UEs with SLSS ID within the configured set of SLSS IDs {X,Y}. Therefore, for synchronization signal (i.e. S-SSB) power control, the first SyncRef UE 206 may be configured to consider the second SyncRef UE 208 and the third SyncRef UE 210.

In addition, the first SyncRef UE can also be configured to consider the first base station 202 (i.e. gNB1) and the second base station 204 (i.e. gNB2) for synchronization signal (i.e. S-SSB) power control, based on a configured set of cell IDs which includes the cell ID of gNB1 and gNB2. Thus, the synchronization signal power control of the first SyncRef UE 206 depends on the RSRP measurements of the second SyncRef UE 208 and the third SyncRef UE 210 as well as on the downlink pathloss (DL PL) of the first base station 202 (i.e. gNB1) and the second base station 204 (i.e. gNB2).

The first SyncRef UE 206 can derive the DL PL of the second base station 204 (i.e. gNB2) based on the RSRP measurement of the second base station 204 (i.e. gNB2) and the transmission (Tx) power which is signalled by the second base station 204 (i.e. gNB2). The configured set of SLSS IDs {X,Y} corresponds to the set of sidelink synchronization signals (SLSS), identifiers (IDs) obtained by the processor 106 of the UE 102 (of FIG. 1A).

For example, the synchronization signal transmission power (also denoted as PS-SSB) of the first SyncRef UE 206 is represented by the equations (equation 1 and equation 2) when lies in the network coverage 202A of the first base station 202.

Case 1: if max(RSRP₁, . . . , RSRPⱼ, . . . )<RSRPₜₕ,

P_{S-SSB}=min(P_{MAX},P_{0,DL}^{S-SSB}+10 log₁₀(2^{μ}·M_{S-SSB})+α_{DL}^{S-SSB}PL_{DL},P_{0,DL,1}^{S-SSB}+10 log₁₀(2^{μ}·M_{S-SSB})+α_{DL,1}^{S-SSB}PL_{DL,1}, . . . ,P_{0,DL,i}^{S-SSB}+10 log₁₀(2^{μ}·M_{S-SSB})+α_{DL,i}^{S-SSB}PL_{DL,1}, . . . ) (1)

Case 2: else if max(RSRP₁, . . . , RSRPⱼ, . . . )≥RSRPₜₕ,

P_{S-SSB}=min(P_{MIN},P_{0,DL}^{S-SSB}+10 log₁₀(2^{μ}·M_{S-SSB})+α_{DL}^{S-SSB}PL_{DL},P_{0,DL,1}^{S-SSB}+10 log₁₀(2^{μ}·M_{S-SSB})+α_{DL,1}^{S-SSB}PL_{DL,1}, . . . ,P_{0,DL,i}^{S-SSB}+10 log₁₀(2^{μ}·M_{S-SSB})+α_{DL,i}^{S-SSB}PL_{DL,1}, . . . ) (2)

where, P_{S-SSB} is S-SSB transmission power of the first SyncRef UE 206, P_{MAX} is the maximum (pre-) configured transmit power, PL_{DL} is the DL PL of the first base station 202 (or the serving base station), PL_{DL,i} is the DL PL of i-th base station with a cell ID among the configured set of cell IDs, (P_{0,DL}^{S-SSB}, α_{DL}^{S-SSB}) and (P_{0,DL,i}^{S-SSB}, α_{DL,i}^{S-SSB}) are power control parameters (i.e. nominal power and alpha parameter used for fractional power control) associated with the PL_{DL} and PL_{DL,i}, respectively. Moreover, P_{MIN} is defined and discussed in detail, for example, in FIGS. 5B and 5C.

RSRP is the RSRP of the second SyncRef UE 208 (or the third SyncRef UE 210) with the j-th SLSS ID and the resource from the (pre) configured set of SLSS IDs and the (pre-) configured set of resources for S-SSB transmission, RSRPₜₕ is the (pre-) configured RSRP threshold value, where, RSRPₜₕ can be determined based on the minimum required RSRP for selecting a SyncRef UE plus an offset.

And μ is defined as a sub carrier spacing configuration factor depending on the numerology, M_{S_SSB} is the number of physical resource blocks used for the S-SSB transmission and P_{MIN} can be determined based on the use case.

The first SyncRef UE 206 does not consider all nearby synchronization sources such as the fourth SyncRef UE 212, because the fourth SyncRef UE 212 manifests a SLSS ID (e.g. SLSS ID Z) which is not present in the configured set of SLSS ID {X,Y} Therefore, the S-SSB power control of the first SyncRef UE 206 does not depend on the RSRP measurement of the fourth SyncRef UE 212. Alternatively stated, the fourth SyncRef UE 212 has lower priority than the first SyncRef UE 206.

FIG. 2B is a schematic representation of S-SSB power control of the user equipment (UE) when lies outside of the network coverage of a base station, in accordance with an embodiment of the present disclosure. FIG. 2B is described in conjunction with elements from FIGS. 1A, 1B, and 2A. With reference to FIG. 2B, there is shown a schematic representation 200B that includes a fifth SyncRef UE 214.

The UE 102 (of FIG. 1A) lies outside the network coverage 202A of a base station, such as the first base station 202, and triggered to act as the first SyncRef UE 206 for transmitting the synchronization signal (i.e. S-SSB). The first SyncRef UE 206 selects another user equipment as its synchronization source, for example, the second SyncRef UE 208.

The second SyncRef UE 208 may transmit the synchronization signal (i.e. S-SSB) with an SLSS ID W and on a resource #1 (res. #1), where the resource #1 corresponds to the time and frequency values. Before the first SyncRef UE 206 is triggered to transmit the synchronization signal (i.e. S-SSB), other nearby SyncRef UEs have been triggered to transmit synchronization signal.

For example, the plurality of other SyncRef UEs, such as the second SyncRef UE 208, the third SyncRef UE 210, the fourth SyncRef UE 212 and the fifth SyncRef UE 214 have been triggered to transmit synchronization signal. The second SyncRef UE 208 is the synchronization source of first SyncRef UE 206, and of the third SyncRef UE 210.

Further, depending on the priority of the second SyncRef UE 208, in some cases, the first SyncRef UE 206 may be configured to transmit the synchronization signal (i.e. S-SSB) with the SLSS ID X, while in some other cases with an SLSS ID W, where, W=X+336.

In this embodiment, the second SyncRef UE 208 may transmit the synchronization signal with the SLSS ID W and on the resource #1 and the first SyncRef UE 206 may transmit the synchronization signal on a resource #2 (res. #2). Therefore, the resource #1 and the resource #2 are the two resources associated with the synchronization signal provided by the second SyncRef UE 208.

For synchronization signal (i.e. S-SSB) power control of the first SyncRef UE 206, the first SyncRef UE 206 may be pre-configured to consider SyncRef UEs (such as the second SyncRef UE 208 and the third SyncRef UE 210) with an SLSS ID within the set of SLSS IDs {W,X} and with synchronization signal transmissions on a resource within the set of resources {resource #1, resource #2}.

For the set of SLSS IDs, W corresponds to the SLSS ID used by a synchronization source of the first SyncRef UE 206, such as the second SyncRef UE 208 and X=W+336, which corresponds to the SLSS ID used by a SyncRef UE which has the second SyncRef UE 208 as its synchronization source, such as the third SyncRef UE 210.

Thus, synchronization signal (i.e. S-SSB) power control of the first SyncRef UE 206 may be based on RSRP measurements of the second SyncRef UE 208 (with the SLSS ID W and synchronization signal transmission on the resource #1) and the third SyncRef UE 210 (with the SLSS ID X and synchronization signal transmission on the resource #2).

The first SyncRef UE 206 may not consider all nearby synchronization sources such as the fourth SyncRef UE 212, and the fifth SyncRef UE 214. The reason may be the fourth SyncRef UE 212 manifests a SLSS ID Y which is not present in the pre-configured set of SLSS IDs {W, X,}. Alternatively stated, the fourth SyncRef UE 212 manifests another timing for the synchronization signal transmission.

The fifth SyncRef UE 214 uses the SLSS ID X, in spite of this, the synchronization signal (i.e. S-SSB) power control of the first SyncRef UE 206 may not depend on the RSRP of the fifth SyncRef UE 214, because the fifth SyncRef UE 214 is not transmitting the synchronization signal on the resource #1 or the resource #2.

Therefore, similar to the fourth SyncRef UE 212, the fifth SyncRef UE 214 has another timing for synchronization signal transmission. In this way, the S-SSB power control of the first SyncRef UE 206 does not depend on the RSRP measurements of the fourth SyncRef UE 212 and the fifth SyncRef UE 214.

FIG. 3A is a schematic representation of a beam based S-SSB power control of the user equipment (UE) when lies in the network coverage of a base station, in accordance with an embodiment of the present disclosure. FIG. 3A is described in conjunction with elements from FIGS. 1A, 1B, and 2A. With reference to FIG. 3A, there is shown a schematic representation 300A that may include a synchronization coverage 302A and a plurality of beams such as beams b1-b8 of the first SyncRef UE 206 (of FIG. 2A).

With the beam based S-SSB power control, the power control for S-SSB transmission on a given beam of the first SyncRef UE 206 depends on measurements obtained with the given beam (i.e. based on beam-specific measurements). The first SyncRef UE 206 lies in the network coverage 202A of the first base station 202.

The first SyncRef UE 206 may configured to consider the second SyncRef UE 208 (because of having the SLSS ID X in the configured set of SLSS IDs {X,Y} of the first SyncRef UE 206), the third SyncRef UE 210 (because of having the SLSS ID Yin the configured set of SLSS IDs {X,Y} of the first SyncRef UE 206), the first base station 202 (i.e. the serving base station) and the second base station 204 (i.e. nearby base station) for the S-SSB power control.

The RSRP measurements of the first base station 202 (i.e. gNB1), the second base station 204 (i.e. gNB2), the second SyncRef UE 208, and the third SyncRef UE 210 are different across the plurality of beams such as the beams b1-b8 of the first SyncRef UE 206.

Based on beam-specific measurements over the plurality of beams such as the beams b1-b8 of the first SyncRef UE 206, the S-SSB power control of the first SyncRef UE 206 leads to different transmit (Tx) power across the plurality of beams such as the beams b1-b8.

For example, the highest RSRP measurements of the first base station 202 (i.e. gNB1) are received on the beam b1 and the beam b2, the highest RSRP measurements of the second SyncRef UE 208 are received on the beam b3, the highest RSRP measurements of the third SyncRef UE 210 are received on the beam b5, and the highest RSRP measurements of the second base station 204 (i.e. gNB2) are received on the beam b6.

Thus, the transmit power of S-SSBs transmitted by the first SyncRef UE 206 on the beam b1 and the beam b2 is limited by the DL PL of the first base station 202 (i.e. gNB1), and the transmit power of S-SSBs transmitted on the beam b3 is limited by the RSRP measurements of the second SyncRef UE 208.

In addition, the transmit power of S-SSB transmitted on the beam b5 is limited by the RSRP measurements of the third SyncRef UE 210, and the transmit power of S-SSBs transmitted on the beam b6 is limited by the DL PL of the second base station 204 (i.e. gNB2).

However, the transmit power of S-SSBs transmitted by the first SyncRef UE 206 on the beam b4, the beam b7, and the beam b8 is not limited by either the DL PL or the RSRP measurements of the nearby synchronization sources (i.e. nearby base stations or nearby SyncRef UEs).

Therefore, the first SyncRef UE 206 can transmit with a high transmit power (e.g. maximum transmit power) on the beam b4, the beam b7, and the beam b8. The synchronization coverage 302A indicates an efficient expansion of the synchronization coverage of the first SyncRef UE 206, when the first SyncRef UE 206 lies in the network coverage 202A of the first base station 202 (i.e. gNB1).

The equations (equation 1 and equation 2) can be extended to determine the beam based S-SSB power control of the first SyncRef UE 206. The transmit power (also represented as PS-SSB,b) of S-SSBs transmitted by the first SyncRef UE 206 with the plurality of beams such as the beams b1-b8, may be determined by considering the beam specific measurements such as PL_{DL,b}, PL_{DL,i,b} and RSRP_{j,b} corresponding to the measurements of the first SyncRef UE 206 with the plurality of beams such as the beams b1-b8.

FIG. 3B is a schematic representation of a beam based S-SSB power control of the user equipment (UE) when lies out of network coverage of a base station, in accordance with an embodiment of the present disclosure. FIG. 3B is described in conjunction with elements from FIGS. 1A, 1B, 2B, and 3A. With reference to FIG. 3B, there is shown a schematic representation 300B that includes a synchronization coverage 302B and a plurality of beams such as beams b1′-b8′ of the first SyncRef UE 206 (of FIG. 2A).

The first SyncRef UE 206 lies out of the network coverage 202A of the first base station 202. The first SyncRef UE 206 is configured to consider the second SyncRef UE 208 because of having the SLSS ID Win the configured set of SLSS IDs {W, X} of the first SyncRef UE 206, where X=W+336, and, with the synchronization signal transmissions (i.e. S-SSB transmission) on the resource #1 within the configured set of resources {i.e. resource #1, resource #2} of the first SyncRef UE 206 for the S-SSB power control.

In addition, the first SyncRef UE 206 may be configured to consider the third SyncRef UE 210 because of having the SLSS ID X in the configured set of SLSS IDs {W, X} of the first SyncRef UE 206, and, with the synchronization signal transmissions (i.e. S-SSB transmission) on the resource #2 within the configured set of resources {i.e. resource #1, resource #2} of the first SyncRef UE 206 for the S-SSB power control. The RSRP measurements of the second SyncRef UE 208, and the third SyncRef UE 210 are different across the plurality of beams such as the beams b1′-b8′ of the first SyncRef UE 206.

Based on beam-specific measurements over the plurality of beams such as the beams b1′-b8′ of the first SyncRef UE 206, the S-SSB power control of the first SyncRef UE 206 leads to different transmit (Tx) power across the plurality of beams such as the beams b1′-b8′.

For example, the highest RSRP measurements of the second SyncRef UE 208 may be received on the beams b 1′ and the beam b2′, and the highest RSRP measurements of the third SyncRef UE 210 are received on the beam b3′. Thus, the transmit power of S-SSBs transmitted by the first SyncRef UE 206 on the beam b1′ and the beam b2′ is limited by the RSRP measurements of the second SyncRef UE 208, and the transmit power of S-SSBs transmitted on the beam b3′ is limited by the RSRP measurements of the third SyncRef UE 210.

However, the transmit power of S-SSBs transmitted by the first SyncRef UE 206 on the beam b4′, the beam b5′, the beam b6′, the beam b7′ and the beam b8′ is not limited by the RSRP measurements of nearby synchronization sources.

Therefore, the first SyncRef UE 206 can transmit with a high transmit power (e.g. maximum transmit power) on the beam b4′, the beam b5′, the beam b6′, the beam b7′ and the beam b8′. Moreover, the RSRP measurement of the first SyncRef UE 206 can be different with each beam, therefore, the beam-based S-SSB power control allows the first SyncRef UE 206 to transmit the synchronization signal (i.e. S-SSB) at a different transmit power on each beam.

Hence, the beamforming can further enhance the efficiency of the synchronization coverage expansion of the first SyncRef UE 206. The synchronization coverage 302B indicates an efficient expansion of the synchronization coverage of the first SyncRef UE 206, when the first SyncRef UE 206 lies out of the network coverage 202A of the first base station 202 (i.e. gNB1).

FIG. 4 is a flowchart of a method of S-SSB power control of the user equipment in accordance with another embodiment of the present disclosure. FIG. 4 is described in conjunction with the elements from FIGS. 1A, 1B, 2A, 2B, 3A, and 3B. With reference to FIG. 4, there is shown a method 400 that includes steps 402, 404, 406, 408, 410A, 410B, 412, 414, 416 and 418. The method 400 is executed by the UE 102 (of FIG. 1A).

At step 402, the method 400 comprises providing the UE 102 a (pre-) configured set of SLSS IDs, a (pre-) configured set of resources for S-SSB transmission and a (pre-) configured set of cell IDs (when lies in network coverage).

At step 404, the method 400 may further comprise configuring the UE 102 to receive a first signal from nearby synchronization sources such as nearby base stations or nearby SyncRef UEs.

In an example, the first signal may include a SLSS ID and/or a resource for S-SSB transmission of nearby SyncRef UEs. In another example, the first signal includes a cell ID of nearby base stations.

The UE 102 may be configured to distinguish the SLSS ID of the nearby SyncRef UEs based on the received SLSS ID (in the first signal) of the nearby SyncRef UEs.

In addition, the UE 102 may be further configured to distinguish the resources (i.e. time and frequency) on which it receives the first signal from the nearby SyncRef UEs.

In a case, when the UE 102 lies in network coverage of the nearby base stations, then, the UE 102 is configured to distinguish the cell ID based on the received cell ID (in the first signal) of the nearby base stations. Based on the (pre-) configured set of SLSS IDs, the (pre-) configured set of resources for S-SSB transmission and the (pre-) configured set of cell IDs (when lies in network coverage), the UE 102 is configured to determine which of the nearby synchronization sources are considered for the S-SSB power control.

Alternatively stated, the UE 102 may be configured to select the SyncRef UEs (e.g. the second SyncRef UE 208, the third SyncRef UE 210, and the like) those have the SLSS ID among the configured set of SLSS IDs of the UE 102 and the resources for the S-SSB transmission among the configured set of resources associated with the S-SSB transmission of the UE 102.

Additionally, the UE 102 may be configured to select the base stations those have the cell ID among the configured set of cell IDs of the UE 102 (when lies in network coverage).

Therefore, the S-SSB power control of the UE 102 may depend on the RSRP measurements of the selected SyncRef UEs and the selected base stations. The steps 402 and 404 of the method 400 are executed by the transceiver 104 of the UE 102.

At step 406, the method 400 may further comprise determining whether the UE 102 is transmitting data or not. In a case, if the UE 102 is transmitting data then the steps 408 and 410A are executed for the S-SSB power control of the UE 102. In another case, if the UE 102 is not transmitting data then the steps 410B, 412, 414, 416 and 418 are executed for the S-SSB power control of the UE 102.

At step 408, the method 400 may further comprise determining the S-SSB power control of the UE 102 based on a transmit power of the data transmission and a (pre-) configured power offset value.

At step 410A, the method 400 may further comprise providing the UE 102 the (pre-) configured power offset value. The (pre-) configured power offset value corresponds to a data/sync offset between the Tx power of the data transmission and the Tx power of S-SSB transmission.

At step 412, the method 400 may further comprise selecting a SyncRef UE as a synchronization source of the UE 102 and determining whether the highest RSRP of all nearby SyncRef UEs is associated with the selected SyncRef UE.

For this comparison, at step 414, the method 400 may further comprise receiving the RSRP measurements of the selected SyncRef UEs and the selected base stations. In a case, if the selected SyncRef UE has highest RSRP measurement then the steps 416 and 410B are executed, else the step 418 is executed.

At step 416, the method 400 may further comprise determining the S-SSB power control of the UE 102 based on the RSRP measurements of selected synchronization sources (i.e. SyncRef UEs and base stations) and a (pre-) configured power offset value.

At step 410B, the method 400 may comprise providing the UE 102 the (pre-) configured power offset value for the S-SSB power control.

At step 418, the method 400 may further comprise determining the S-SSB power control of the UE 102 based on the RSRP measurements of selected synchronization sources (i.e. SyncRef UEs and base stations) and on the maximum Tx power. The steps 406, 408, 410A, 410B, 412, 414, 416 and 418 are executed by the processor 106 of the UE 102.

The steps 402, 404, 406, 408, 410A, 410B, 412, 414, 416 and 418 are only illustrative and other alternatives can also be provided where one or more steps are added, one or more steps are removed, or one or more steps are provided in a different sequence without departing from the scope of the claims here.

FIG. 5A is an exemplary implementation of S-SSB power control of the first SyncRef UE in accordance with an embodiment of the present disclosure. FIG. 5A is described in conjunction with elements from FIGS. 1A, 1B, 2A, 2B, and 4. With reference to FIG. 5A, there is shown an exemplary implementation 500A that represents a SyncRef UE 502. There is further shown a synchronization coverage 502A of the SyncRef UE 502.

The first SyncRef UE 206 (of FIG. 2A) lies out of the network coverage of a base station or GNSS. The SyncRef UE 502 corresponds to a nearest SyncRef UE of the first SyncRef UE 206. The first SyncRef UE 206 (of FIG. 2A) lies close to the synchronization coverage 502A of the SyncRef UE 502 (i.e. the nearest SyncRef UE).

In such an implementation, while computing the S-SSB transmit (Tx) power (i.e. PS-SSB) of the first SyncRef UE 206, the S-SSB transmit (Tx) power (i.e. PS-SSB) of the first SyncRef UE 206 may be set to the PMAX (i.e. the maximum (pre-) configured transmit power) according to the equations (equation 1 and equation 2).

Alternatively, in another embodiment, the first SyncRef UE 206 lies in network coverage (e.g. in the network coverage 202A of the first base station 202, which have been described, for example, in FIG. 2A), then the S-SSB Tx power (i.e. PS-SSB) of the first SyncRef UE 206 may be computed according to the equations (equation 1 and equation 2). That is, by considering the PMAX as well as the DL PL of the serving base station (i.e. the first base station 202) and the DL PL of the nearby base stations, such as, the base stations with the cell IDs among the configured set of cell IDs of the first SyncRef UE 206.

FIG. 5B is an exemplary implementation of S-SSB power control of the first SyncRef UE when the first SyncRef UE is transmitting data, in accordance with an embodiment of the present disclosure. FIG. 5B is described in conjunction with elements from FIGS. 1A, 2A, 2B, 4, and 5A. With reference to FIG. 5B, there is shown an exemplary implementation 500B that represents a receive UE 504.

The receive UE 504 may be configured to receive the data from the first SyncRef UE 206. Example of the receive UE 504 may include but are not limited to, a mobile device, an automatic vehicle, a semi-automatic vehicle, a vehicle, a robot, or other portable or non-portable communication device, and the like.

The first SyncRef UE 206 may be configured to transmit data (e.g. a physical sidelink shared channel (PSSCH)), with a k-th PSSCH sent with a power PPSSCH,k (e.g. P_{PSSCH,1}) to the receive UE 504.

In addition, the first SyncRef UE 206 lies out of the synchronization coverage 502A of the SyncRef UE 502 (i.e. the nearest SyncRef UE of the first SyncRef UE 206). Thus, equation 2 applies and equation 1 does not apply.

Therefore, the S-SSB Tx power (i.e. PS-SSB) of the first SyncRef UE 206 may be based on the maximum Tx power of the data transmissions to the receive UE 504 plus a data/sync offset, according to the equation 2 with P_{MIN} (described in detail, for example, in FIG. 2A) given by equation 3.

P_{MIN}=max(P_{PSSCH,1}, . . . ,P_{PSSCH,k}, . . . )+(pre-)configured offset (3)

where, P_{MIN} is the minimum (pre-) configured transmit power,max)P_{PSSCH,1}, . . . , P_{PSSCH,k}, . . . ) is maximum Tx power of data transmission, and the (pre-) configured offset corresponds to a data/sync offset. The S-SSB Tx power (i.e. PS-SSB) of the first SyncRef UE 206 enables the synchronization coverage of the first SyncRef UE 206 to be larger than the largest PSSCH coverage.

In the exemplary implementation 500B, the S-SSB Tx power (i.e. PS-SSB) of the first SyncRef UE 206 may be set according to the equation 2 with P_{MIN} given by equation 4 (which consists of equation 3 when the first SyncRef UE 206 has only one data transmission).

P_{MIN}=P_{PSSCH,1}+offset (4)

where, P_{PSSCH,1} is the power associated with the data transmission to the receive UE 504.

Since, the first SyncRef UE 206 lies out of network coverage, therefore, the DL PL of the serving base station (e.g. the first base station 202) and of nearby base stations are not included in the equation 2, for computation of the −SSB Tx power (i.e. PS-SSB) of the first SyncRef UE 206.

Alternatively, if the first SyncRef UE 206 lies in network coverage, therefore, the DL PL of the serving base station (e.g. the first base station 202) and of nearby base stations will be included in the equation 2, for computation of the S-SSB Tx power (i.e. PS-SSB) of the first SyncRef UE 206.

FIG. 5C is an exemplary implementation of S-SSB power control of the first SyncRef UE when the first SyncRef UE is not transmitting data, in accordance with an embodiment of the present disclosure. FIG. 5C is described in conjunction with elements from FIGS. 1A, 2A, 2B, 4, 5A, and 5B. With reference to FIG. 5C, there is shown an exemplary implementation 500C that includes the first SyncRef UE 206 and the SyncRef UE 502 (i.e. the nearest SyncRef UE of the first SyncRef UE 206).

When the first SyncRef UE 206 is not transmitting data (i.e. a PSSCH), then the S-SSB Tx power (i.e. PS-SSB) of the first SyncRef UE 206 may be computed based on equation 2 with P_{MIN} either according to the equation 5 or the equation 6.

P_{MIN}=(pre-)configured value−(max(RSRP₁, . . . ,RSRPⱼ, . . . )−RSRPₜₕ) (5)

P_{MIN}=P_{MAX}−(max(RSRP₁, . . . ,RSRPⱼ, . . . )−RSRPₜₕ) (6)

The S-SSB Tx power (i.e. PS-SSB) of the first SyncRef UE 206 may be based on the (pre-) configured value (or PMAX) and a power reduction (max(RSRP₁, . . . , RSRPⱼ, . . . )−RSRPₜₕ), which is based on strongest RSRP among the considered SyncRef UEs (i.e. the SyncRef UE 502).

The term (max(RSRP₁, . . . , RSRPⱼ, . . . )−RSRPₜₕ) is based on a difference between the RSRP of the SyncRef UE 502 and the RSRP threshold value (i.e. RSRPₜₕ).

The term (max(RSRP₁, . . . , RSRPⱼ, . . . )−RSRPₜₕ) enables the first SyncRef UE 206 to transmit the S-SSBs at a different power depending on a distance from other considered SyncRef UEs (such as the second SyncRef UE 208 or the third SyncRef UE 210).

In a case, if the first SyncRef UE lies out of network coverage and the SyncRef UE 502 is the synchronization source of the first SyncRef UE 206. In other words, the strongest RSRP is associated with the SyncRef UE 502 among the considered SyncRef UEs. The first SyncRef UE 206 lies in the synchronization coverage 502A of the SyncRef UE 502, then the S-SSB Tx power (i.e. PS-SSB) of the first SyncRef UE 206 is determined according equation 2 with P_{MIN} given by the equation 6.

The first SyncRef UE 206 may be configured to transmit S-SSBs with the P_{MAX}, when the first SyncRef UE 206 lies at the edge of the synchronization coverage 502A of the SyncRef UE 502 (i.e. RSRP₁=RSRPₜₕ).

In another case, if the first SyncRef UE lies out of network coverage and the strongest RSRP is not associated with the SyncRef UE 502 among the considered SyncRef UEs, then, the −SSB Tx power (i.e. PS-SSB) of the first SyncRef UE 206 may be determined according to the equation 2 with P_{MIN} given by the equation 5.

In addition to the configured set of cell IDs, (pre-) configured set of SLSS IDs, and (pre-) configured set of resources, a few additional parameters are required for the disclosed S-SSB power control, such as RSRP threshold (RSRPₜₕ), the (pre-) configured data (or sync) offset, the (pre-) configured value nominal power (i.e. P_{0,DL,i}^{S-SSB}), parameter a (i.e. α_{DL,i}^{S-SSB}).

The additional parameters can be signalled by either a base station (such as the first base station 202 when the first SyncRef UE lies in network coverage 202A) or a SyncRef UE (such as the second SyncRef UE 208 or the SyncRef UE 502) when the first SyncRef UE 206 lies out of network coverage. When the first SyncRef UE 206 lies out of network coverage, the additional parameters can be preconfigured also.

Modifications to embodiments of the present disclosure described in the foregoing are possible without departing from the scope of the present disclosure as defined by the accompanying claims. Expressions such as “including”, “comprising”, “incorporating”, “have”, “is” used to describe and claim the present disclosure are intended to be construed in a non-exclusive manner, namely allowing for items, components or elements not explicitly described also to be present. Reference to the singular is also to be construed to relate to the plural. The word “exemplary” is used herein to mean “serving as an example, instance or illustration”. Any embodiment described as “exemplary” is not necessarily to be construed as preferred or advantageous over other embodiments or to exclude the incorporation of features from other embodiments. The word “optionally” is used herein to mean “is provided in some embodiments and not provided in other embodiments”. It is appreciated that certain features of the present disclosure, which are, for clarity, described in the context of separate embodiments, may also be provided in combination in a single embodiment. Conversely, various features of the invention, which are, for brevity, described in the context of a single embodiment, may also be provided separately or in any suitable combination or as suitable in any other described embodiment of the disclosure.

What is claimed is:

1. A User Equipment, UE, (102) arranged to operate sidelink communication, the UE (102) comprising:
a transceiver (104) being configured to receive a first signal from a first synchronization source (108), and
a processor (106) being configured to: obtain a set of sidelink synchronization signal, SLSS, identifiers, IDs; operate power control of transmission of a synchronization signal based on the first signal and the set of SLSS IDs.

2. The UE (102) according to claim 1, wherein the processor (106) is further configured to:
obtain the set of sidelink synchronization signal, SLSS, identifiers, IDs by receiving a set of SLSS IDs from a serving base station, BS (202).

3. The UE (102) according to claim 1, wherein the processor (106) is further configured to:
obtain the set of sidelink synchronization signal, SLSS, identifiers, IDs by receiving a set of SLSS IDs from a synchronization reference, SyncRef, UE (208, 210, 212, 214, 502).

4. The UE (102) according to claim 1, wherein the processor (106) is further configured to:
obtain the set of sidelink synchronization signal SLSS, identifiers, IDs by determining the set of SLSS IDs based on an SLSS ID of a synchronization reference, SyncRef, UE (208, 210, 212, 214, 502) and rules of pre-configuration.

5. The UE (102) according to claim 4, wherein the set of SLSS IDs is determined to include the SLSS ID used by the synchronization reference, SyncRef, UE (208, 210, 212, 214, 502).

6. The UE (102) according to claim 5 further having a priority, wherein the processor (106) is further configured to:
obtain a priority of the synchronization reference, SyncRef, UE (208, 210, 212, 214, 502); include the SLSS ID of the synchronization reference, SyncRef, UE (208, 210, 212, 214, 502) in the set of SLSS IDs when the priority of the synchronization reference, SyncRef, UE (208, 210, 212, 214, 502) is higher than or equal to the priority of the UE (102).

7. The UE (102) according to claim 1, wherein the transceiver (104) is enabled for beamforming wherein the first signal is received on a first beam, and the processor (106) is further configured to operating the power level for transmitting synchronization signal on the first beam.

8. The UE (102) according to claim 1, wherein the first synchronization source (108) is a Base Station, BS, (202) and wherein the processor (106) is further configured to operate the power control based on a DownLink PathLoss, DL PL, of the first signal.

9. The UE (102) according to claim 1, wherein the first synchronization source (108) is a synchronization reference, SyncRef, user equipment, UE, (208, 210, 212, 214, 502) and wherein the processor (106) is further configured to operate the power control based on a Reference Signal Received Power (RSRP) of the first signal.

10. The UE (102) according to claim 9, wherein the processor (106) is further configured to:
compare the Reference Signal Received Power (RSRP) of the first signal with a threshold value and operate the power control based on the comparison.

11. The UE (102) according to claim 1, wherein the processor (106) is further configured to:
determine the power level of a data transmission and operate the power control based on the power level of the data transmission when the UE (102) is transmitting data.

12. The UE (102) according to claim 11, wherein the processor (106) is further configured to:
operate the power control based on the power level of the data transmission and a pre-specified offset value.

13. The UE (102) according to claim 1, wherein the first signal is received from the first synchronization source (108) having a first sidelink synchronization signal, SLSS, identifier, ID, and the processor (106) is configured to operate power control of transmission of a synchronization signal based on the first signal and the set of the set of SLSS IDs by determining when the first SLSS ID is within the set of SLSS IDs.

14. The UE (102) according to claim 1, wherein the UE (102) is arranged for acting as a Synchronization Reference UE (SyncRef UE) (206) in a sidelink communication network.

15. A method (100B, 400) for operating sidelink communication in a User Equipment, UE, (102) wherein the method (100B, 400) comprises receiving a first signal from a first synchronization source (108), obtaining a set of sidelink synchronization signal, SLSS, identifiers, IDs; operating power control of transmission of a synchronization signal based on the first signal and the set of SLSS IDs.
